(19) United States
(12) Patent Application Publication
(10) Pub. No.: US 2002/0083556 A1
(43) Pub. Date: Jul. 4, 2002

(54) Handle of a drawer case for hard disc

(76) Inventor: Chih-Neng Lai, Chia Yi City (TW)

Correspondence Address: ROSENBERG, KLEIN & LEE, SUITE 101, 3458 ELLICOTT CENTER DRIVE, ELLICOTT CITY, MD, 21043, US

(21) Appl. No.: 09/753,567

(22) Filed: Jan. 4, 2001

(51) Int. Cl. E05B 1/00

(52) U.S. Cl. 16/415

(57) ABSTRACT

A handle assembly of a drawer case for hard disc includes tow handles each having a laid U-shaped portion and two bent end portions. The bent end portions are passed through pivotal holes on a front plate of the drawer case with projecting parts of the bent end portions detained by an inner side of the front plate. The handles are pivotable on the front plate between an in-use position perpendicular to the front plate for the user to hold to pull out the drawer case, and a not-in-use position where the laid U-shaped portions abut the front plate.

### BACKGROUND OF THE INVENTION

Computers have become a must in modern life of most people. A computer needs a lot of memories to store a variety of programs, data etc. The program could be many mega bytes (MB), even giga bytes (GB). A conventional memory device is not able to provide so many memories. Therefore, hard discs are used for providing such big memory.

A hard disc is provided with a drawer case which can be removed from the computer, and connected to another computer for transferring data.

A conventional drawer case of a hard disc has a handle on a front side; the drawer case has two pivotal holes on two end portions of the front side; the handle is pivoted to the pivotal holes from two ends. The length of the handle is substantially as big as the width of the drawer case because of the position of the pivotal holes. Therefore, the handle is relatively big, needing relatively much material to manufacture. Consequently, the handle needs relatively many parts of the assembly.

### SUMMARY OF THE INVENTION

Therefore, it is a main object of the present invention to provide a handle assembly of a drawer case for hard disc which can overcome the disadvantage of the conventional one.

The handle assembly of a drawer case of a hard disc of the present invention includes two handles each having a laid U-shaped portion and two bent end portions. The bent end portions of the handle are passed through pivotal holes of a front plate of the drawer case with projecting parts thereof detained by an inner side of the front plate for preventing the handles from falling off the front plate.

The handles are pivotable between an in-use position where the laid U-shaped portions are perpendicular to the front plate with the projecting parts abutting the front plate inner side and a not-in-use position where the laid U-shaped portions abuts the front plate.

### BRIEF DESCRIPTION OF THE DRAWINGS

This invention will be better understood by referring to the accompanying drawings, wherein:

FIG. 1 is an exploded perspective view of a drawer case for a hard disc according to the present invention.

FIG. 2 is a side view of the handle assembly of a drawer case for a hard disc according to the present invention.

FIG. 3 is a side view of the handle assembly of the present invention, being moved to the in-use position.

### DESCRIPTION OF THE PREFERRED EMBODIMENT

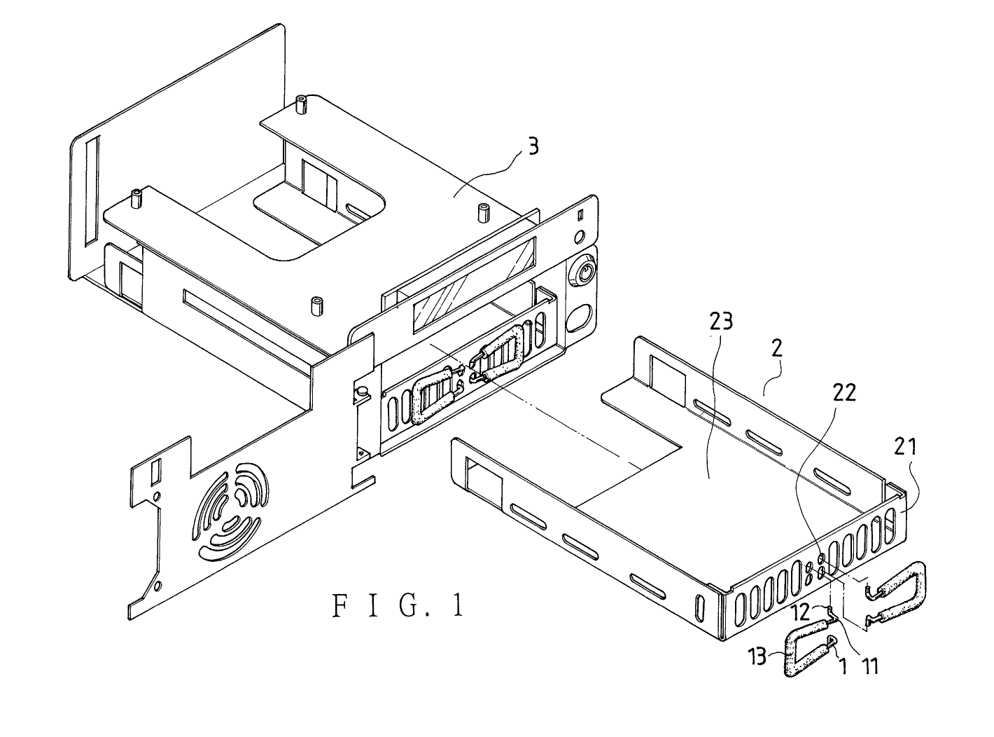

Referring to FIG. 1, a drawer case of a hard disc of the present invention includes a front plate 21, pivotal holes 22, a holding room 23 and a handle assembly including two handles.

The hard disc is disposed in the holding room 23 of the drawer case. A stationary case 3 is fixedly received in the computer for permitting the drawer case 2 with the hard disc to be pushed thereinto and pulled out therefrom.

The front plate 21 is provided on a front side of the drawer case 2. The pivotal holes 22 are provided on the middle part of the front plate 21 including two left ones, and two right ones.

The handles 1 each has a laid U-shaped portions and two bent end portions 11 on two ends; the bent end portions 11 of each handle 1 each further has a projecting part 12 on an outer end.

The left handle 1 is connected to the left top and bottom pivotal holes 22 with the bent end portions 11, and the right handle is connected to the right top and bottom pivotal holes 22 with the bent end portions 11, and the projecting parts are detained in the holding room 23. Thus, the handles 1 cannot separate from the front plate 21, and can pivot on the pivotal holes 22 as shown in FIG. 3.

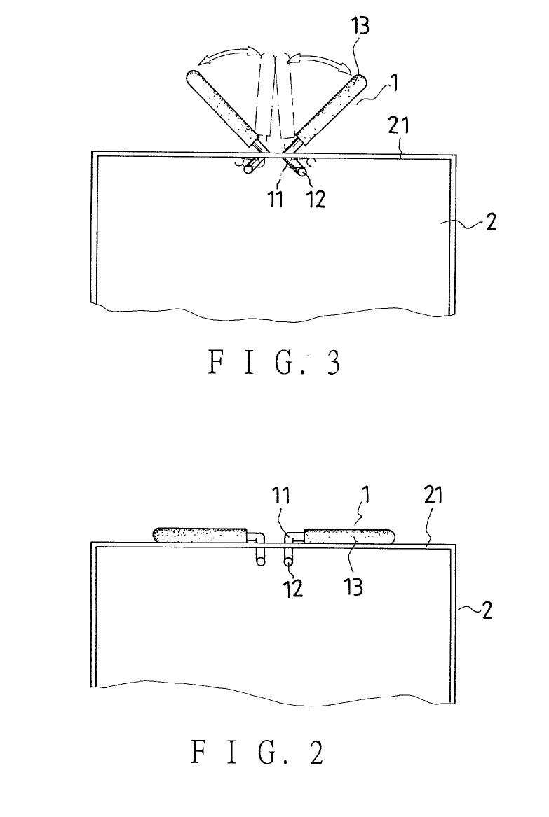

Referring to FIG. 2, when the drawer case 2 with a hard disc is connected to a computer, the handles 1 can be pivoted to a not-in-use position where the outer parts of the handles 1 are disposed to abut the front plate 21 for saving space.

Referring again to FIG. 3, to draw the draw case 2 with the hard disc out from the stationary disc 3, the handles 1 are pivoted to an in-use position where the outer parts of the handles 1 are substantially perpendicular to the front plate with the projecting parts 12 abutting the inner side of the front plate 21 for permitting a user to hold with his fingers. Thus, the drawer case 2 and the hard disc can be pulled out. After the drawer case 2 is pulled out, and the user release the handles 1, the reaction force of the projecting parts 12 and the bent end potions 11 on the inner side of the front plate 21 will move the handles to a substantially laid down position.

Moreover, each of the handles 1 has a protective covering 13 on the outer part of the laid U-shaped portions. The protective covering 13 is made of insulating materials to protect the use from heat and electricity.

From the above description, the handle of a hard disc drawer case of the present invention has a relatively small size. According, the parts of the assembly of the handle are relatively few as compared with the conventional one described in the Bcakground.

What is claimed is:

1. A handle assembly of a hard disc drawer case, comprising
two handles, said handles each having a laid U-shaped portion and two bent end portions; said bent end portions of the left handle being passed through left top and bottom pivotal holes of a drawer case front plate; said bent end portions of the right handle being passed through right top and bottom pivotal holes of a drawer case front plate, said bent end portions each having a projecting part detained by an inner side of said front plate for preventing said handle from separating from said front plate; said handles being pivotable between an in-use position where said laid U-shaped portions are substantially perpendicular to said drawer case front plate with said projecting parts abutting said front plate inner side and a not-in-use position where said laid U-shaped portions abuts said from said front plate.

2. The handle assembly of a hard disc drawer case as claimed in claim 1, wherein said laid U-shaped portions of said handles have protective coverings.
